(19) United States
(12) Patent Application Publication
(10) Pub. No.: US 2016/0315526 A1
(43) Pub. Date: Oct. 27, 2016

(54) ROTARY ELECTRIC MACHINE ROTOR

(71) Applicants: TOYOTA JIDOSHA KABUSHIKI KAISHA, Toyota-shi, Aichi-ken (JP); TSUDA INDUSTRIES CO., LTD., Kariya-shi, Aichi-ken (JP)

(72) Inventors: Keiichi Kaneshige, Seto-shi (JP); Masashi Matsumoto, Nagoya-shi (JP); Yasuaki Shirasaki, Nagoya-shi (JP)

(73) Assignees: TOYOTA JIDOSHA KABUSHIKI KAISHA, Toyota-shi, Aichi-ken (JP); TSUDA INDUSTRIES CO., LTD., Kariya-shi, Aichi-ken (JP)

(21) Appl. No.: 15/102,031

(22) PCT Filed: Dec. 4, 2014
(86) PCT No.: PCT/IB2014/002663

§ 371 Date: Jun. 6, 2016

(30) Foreign Application Priority Data
Dec. 11, 2013 (JP) 2013-255590

(51) Int. Cl. H02K 15/02

(52) U.S. Cl. CPC H02K 15/02

(57) ABSTRACT

A rotary electric machine rotor includes a rotor core, a rotor shaft, and a nut portion. The rotor core is made up of stacked thin magnetic plates. The rotor shaft has, on one end side, a receiving portion that abuts against one end surface in an axial direction of the rotor core, and has, on the other end side, an outer diameter threaded structure. The nut portion meshes with the outer diameter threaded structure of the rotor shaft. A position, on the rotor shaft, of a contact surface between the nut portion and the rotor core is positioned farther to the other end side in the axial direction than the outer diameter threaded structure, when the rotor core is fixed to the rotor shaft by the nut portion being fastened to the outer diameter threaded structure of the rotor shaft.

### BACKGROUND OF THE INVENTION

1. Field of the Invention

The invention relates to a rotary electric machine rotor. More particularly, the invention relates to a rotary electric machine rotor in which a rotor core formed by stacked thin magnetic plates is fixed to a rotor shaft.

2. Description of Related Art

Regarding a rotary electric machine rotor, Japanese Patent Application Publication No. 2002-095197 (JP 2002-095197 A) states that a method that fixes a rotor shaft to a rotor core in which electromagnetic steel sheets are stacked together by press-fitting the rotor shaft into the core deforms the electromagnetic steel sheets. JP 2002-095197 A therefore describes a method in which a loose fit instead of a press fit is used, such as (1) adhesion, (2) press-fitting a bush into a gap, and (3) cutting a thread in the shaft and pushing with a nut.

Japanese Patent Application Publication No. 2001-045724 (JP 2001-045724 A) describes stacking rotor blanking plates in which through-holes are provided in steel plates, and fixing these plates together with a flanged core bar having a threaded portion, and a nut.

Japanese Patent Application Publication No. 2013-106406 (JP 2013-106406 A) describes a fixing method for a rotor core in which end plates are arranged on both sides of stacked electromagnetic steel plates, that does not use a threaded structure. Here, a step that pushes against a second plate side is provided on the rotor shaft, a protrusion is provided on an inner peripheral side of a first end plate, and a rotor shaft is provided in a groove that receives this protrusion. Also, stacked electromagnetic steel plates are compressed by pushing the first end plate toward the first end plate side, the protrusion of the first end plate is fit into the groove in the rotor shaft, and the electromagnetic steel plates that are sandwiched between the end plates on both sides are fixed to the rotor shaft by the spring back of these stacked electromagnetic steel plates.

A method of providing a threaded structure on the rotor shaft and fixing the rotor core to the rotor shaft with a nut conventionally involves aligning an end portion of the threaded structure provided on the rotor shaft with an end portion of the rotor core. As a result, when an inner diameter hole of the rotor core is inserted over (i.e., fit around) an outer shape of the rotor shaft, it does not overlap with the threaded structure, so the fit is stable. If there is dimensional variation in the axial direction of the rotor core, there will be a gap between the end portion of the threaded structure and the end portion of the rotor core, and because there is no threaded structure in this gap, tightening by the nut is insufficient, so the rotor core is unable to be reliably fixed in the axial direction. More specifically, when the rotor core is formed by a stacked structure of thin magnetic plates, dimensional variation in the axial direction of the rotor core due to the stacking gaps is large, so it is difficult to tighten and fix the rotor core to the rotor shaft with a predetermined tightening force.

### SUMMARY OF THE INVENTION

In view of the foregoing problem, the invention provides a rotary electric machine rotor in which a rotor core is able to be fixed to a rotor shaft with a predetermined tightening force regardless of dimensional variation in the axial direction of the rotor core.

A first aspect of the invention relates to a rotary electric machine rotor that includes a rotor core, a rotor shaft, and a nut portion. The rotor core is provided by stacked thin magnetic plates, and the rotor core has a center hole in the rotor core. The rotor shaft has a receiving portion on one end side of the rotor shaft and an outer diameter threaded structure on the other end side of the rotor shaft. The receiving portion is configured to abut on one end surface in an axial direction of the rotor core, and an outer shape of the rotor shaft passes through the center hole of the rotor core. The nut portion meshes with the outer diameter threaded structure of the rotor shaft. With the nut portion, a position, on the rotor shaft, of a contact surface between the nut portion and the rotor core is offset by a predetermined distance in the axial direction from a position on one end side in the axial direction of the outer diameter threaded structure, when the nut portion is fastened to the outer diameter threaded structure of the rotor shaft and the rotor core is fixed to the rotor shaft by the nut portion.

Also, in the rotary electric machine rotor described above, the position, on the rotor shaft, of the contact surface between the nut portion and the rotor core may be positioned farther to the other end side in the axial direction than the position on the one end side in the axial direction of the outer diameter threaded structure, when the nut portion is fastened to the outer diameter threaded structure of the rotor shaft and the rotor core is fixed to the rotor shaft by the nut portion.

Also, in the rotary electric machine rotor described above, the nut portion may have a thin crimping portion that extends to the other end side in the axial direction.

Also, in the rotary electric machine rotor described above, the position on the one end side in the axial direction of the outer diameter threaded structure may be farther to the rotor core side than the position of the contact surface between the nut portion and the rotor core by equal to or greater than one screw pitch of the outer diameter threaded structure. Moreover, in the rotary electric machine rotor described above, the position on the one end side in the axial direction of the outer diameter threaded structure may be farther to the rotor core side than the position of the contact surface between the nut portion and the rotor core by equal to or greater than one screw pitch and within three screw pitches of the outer diameter threaded structure.

Also, in the rotary electric machine rotor described above, the receiving portion may be a stepped portion provided on the one end side of the rotor shaft.

Also, in the rotary electric machine rotor described above, the nut portion may also have a flange portion that protrudes out to the one end side in the axial direction from a threaded shaft portion, the threaded shaft portion being configured to mesh with the outer diameter threaded structure of the rotor shaft, and the flange portion having a larger outer shape than the threaded shaft portion, and the flange portion being configured to push on the other end surface of the rotor core. The position, on the rotor shaft, of a contact surface between the flange portion of the nut portion and the rotor core may be positioned farther to the one end side in the axial direction than the position on the one end side in the axial direction of the outer diameter threaded structure, when the nut portion is fastened to the outer diameter threaded structure of the rotor shaft and the rotor core is fixed to the rotor shaft by the nut portion.

As described above, the rotary electric machine rotor according to the invention is such that the rotor core is made to abut against the receiving portion of the one end portion of the rotor shaft, and the rotor core is fixed to the rotor shaft using the nut portion that meshes with the outer diameter threaded structure on the other end portion of the rotor shaft. In this state, the position of the contact surface between the nut portion and the rotor core is positioned farther to the other end side in the axial direction than the outer diameter threaded structure. That is, the rotor core and the outer diameter threaded structure overlap, so even if there is variation in which the dimension in the axial direction of the rotor core is short, the nut portion is able to be pushed toward the side with the rotor core, such that a predetermined tightening force can be obtained. In this way, even if there is dimensional variation in the axial direction of the rotor core, the rotor core is able to be pushed by the nut portion. Therefore, the rotor core is able to be fixed to the rotor shaft with a predetermined tightening force regardless of dimensional variation in the axial direction of the rotor core.

Also, in the rotary electric machine rotor described above, the nut portion is fixed by crimping to the outer diameter threaded structure of the rotor shaft using the thin crimping portion. Therefore, the rotor core is able to be fixed to the rotor shaft under a predetermined tightening force without loosening.

Also, in the rotary electric machine rotor described above, the position of the contact surface between the nut portion and the rotor core is farther to, the rotor core side than the outer diameter threaded structure by one or more pitches of the outer diameter threaded structure. Therefore, the rotor core is able to be fixed to the rotor shaft with a predetermined tightening force as long as the dimensional variation is within this range.

In the rotary electric machine rotor according to the invention, the receiving portion is a stepped portion provided on one end side of the rotor shaft. Therefore, the rotor core is able to be fixed to the rotor shaft with a simple structure, by abutting one end surface of the rotor core against the receiving portion of the rotor shaft and pushing and fastening it there with a predetermined tightening force regardless of dimensional variation in the axial direction of the rotor core.

Also, in the rotary electric machine rotor described above, the nut portion also has the flange portion that protrudes out to the one end side from a threaded shaft portion that is a portion that is configured to mesh with the outer diameter threaded structure of the rotor shaft. This nut portion fixes the rotor core to the rotor shaft by this flange portion. In this state, the position, on the rotor shaft, of the contact surface between the flange portion and the rotor core is able to be positioned farther to one end side in the axial direction than the outer diameter threaded structure. That is, the rotor core is able to be pushed by the flange portion of the nut portion, while stabilizing the fit between the rotor core and the rotor shaft by not having the outer diameter threaded structure overlap with the rotor core. Therefore, the rotor core is able to be fixed to the rotor shaft with a predetermined tightening force regardless of dimensional variation in the axial direction of the rotor core.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram of a rotary electric machine according to a first example embodiment of the invention;

FIG. 2 is a partial enlarged view of FIG. 1;

FIG. 3 is a views of a nut portion used in the rotary electric machine according to the first example embodiment, (a) is a sectional view, (b) is a top plan view, (c) is a view of the nut portion before a thin crimping portion is crimped, and (d) is a view of the nut portion after the thin crimping portion is crimped;

FIG. 4 is a block view of a rotary electric machine according to a second example embodiment of the invention; and

FIG. 5 is a partial enlarged view of FIG. 4.

### DETAILED DESCRIPTION OF EMBODIMENTS

Hereinafter, example embodiments of the invention will be described in detail with reference to the accompanying drawings. The dimensions, shapes, and materials and the like described below are only examples for the purpose of description and may be modified as appropriate according to the specifications and the like of the rotary electric machine rotor. Also, in the description below, like reference characters will be used to denote like elements throughout all of the drawings, and redundant descriptions will be omitted.

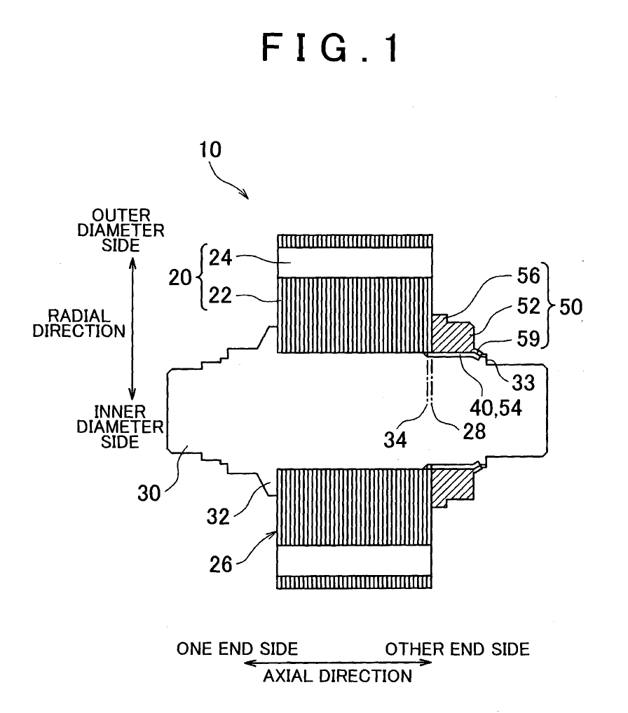

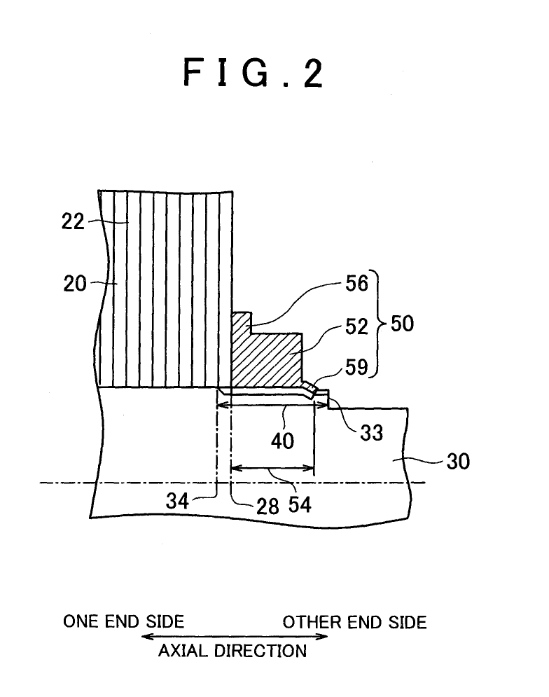

FIG. 1 is a view of the structure of a rotary electric machine rotor 10 according to a first example embodiment used as a rotary electric machine mounted in a vehicle. Hereinafter, unless otherwise specified, the rotary electric machine rotor 10 will simply be referred to as “the rotor 10”. FIG. 2 is a partial enlarged view of FIG. 1.

A rotary electric machine that uses the rotor 10 is a three-phase synchronous rotary electric machine that is a motor-generator that functions as an electric motor when a vehicle is powering, and functions as a generator when the vehicle is braking. The rotary electric machine is formed by a rotor 10 shown in FIG. 1, and an annular stator around which a winding coil is wound, and that is arranged separated by a predetermined gap from an outer peripheral side of the rotor 10. The stator is not shown in FIG. 1. FIG. 1 is a view showing an axial direction of the rotor 10, and both end sides (i.e., one end side and the other end side) of the rotor 10.

The rotor 10 includes a rotor core 20, a rotor shaft 30 onto which the rotor core 20 is fit, and a nut portion 50 that meshes with an outer diameter threaded structure 40. The rotor 10 has a structure that is able to fix the rotor core 20 to the rotor shaft 30 with a predetermined tightening force even if there is dimensional variation in the axial direction of the rotor core 20.

The rotor core 20 includes a stacked body 22 formed by predetermined number of thin magnetic plates that are stacked together, and a plurality of magnets 24 arranged embedded in the stacked body 22.

The stacked body 22 of stacked thin magnetic plates has a center hole through which the outer shape of the rotor shaft 30 passes, and a plurality of magnet holes into which the plurality of magnets 24 are inserted. Electromagnetic steel plates may be used for the thin magnetic plates. The stacking direction is a direction along the axial direction of the rotor 10. The center hole and magnet holes pass through the stacked body 22, extending in a direction parallel to the axial direction of the stacked body 22.

The rotor core 20 is formed by the stacked body 22 of stacked thin magnetic plates, so the dimension in the axial direction thereof is the dimension in the axial direction of the stacked body 22. The thin magnetic plates are stacked and integrated by crimping together a predetermined number of thin magnetic plates that have been punched out in a predetermined shape, for example, so there is a minute stacking gap between adjacent thin magnetic plates. There is also dimensional variation in the axial direction of the stacked body 22 and the rotor core 20 due to variation in plate thickness of the thin magnetic plates and variation in the stacking gaps when the thin magnetic plates are stacked, and the like. The manner in which this dimensional variation in the axial direction is absorbed and the rotor core 20 is fixed to the rotor shaft 30 will be later explained.

A plurality of the magnets 24 are permanent magnets that are arranged in a predetermined arrangement on the outer peripheral sides of the rotor core 20, with each of these magnets 24 forming a magnetic pole of the rotor 10. The magnets 24 generate torque by which the rotor 10 rotates, by working in cooperation with a rotating magnetic field generated by passing a predetermined current through a winding coil that is wound around a stator of a rotary electric machine, not shown. Rare earth magnets such as neodymium magnets mainly composed of neodymium, iron, or samarium cobalt magnets mainly composed of samarium and cobalt may be used as the magnets 24.

The rotor shaft 30 is a shaft that has a receiving portion 32 that abuts against one end surface in the axial direction of the rotor core 20 on one end side, and the outer diameter threaded structure 40 on the other end side. The rotor core 20 is fit onto this rotor shaft 30 from the other end side toward the receiving portion 32. When the rotor 10 is used as a rotary electric machine, the rotor shaft 30 is rotatably supported at both ends in the axial direction by bearings, so the rotor shaft 30 rotates together with a stator, not shown. In this way, the rotor shaft 30 of the rotary electric machine is an output shaft that outputs torque. This rotor shaft 30 may be made of steel that has been machined in a predetermined shape.

The receiving portion 32 is a stepped portion provided on one end side of the rotor shaft 30. A surface on the other end side of the step is perpendicular to the axial direction. The size of the step is set large enough to ensure a receiving area capable of sufficiently receiving the tightening force when one end surface of the rotor core 20 is abutted against the step and the rotor core 20 is fastened with a predetermined tightening force by the nut portion 50.

The outer diameter threaded structure 40 is a male thread provided extending from the other end side of the rotor shaft 30 to the one end side thereof. The outer diameter of the male thread of the outer diameter threaded structure 40 is set slightly smaller than the diameter of the center hole of the rotor core 20. This dimensional difference becomes a clearance (i.e., a gap distance) when the rotor shaft 30 passes through the center hole of the rotor core 20. FIGS. 1 and 2 are views illustrating a position 33 of the outer diameter threaded portion on the other end side and a position 34 of the outer diameter threaded portion on the one end side. The area between position 33 and position 34 is the area where the outer diameter threaded structure 40 is provided.

The nut portion 50 has an inner diameter thread 54 that meshes with the outer diameter threaded structure 40 of the rotor shaft 30. With the rotor core 20 fit onto the rotor shaft 30, the nut portion 50 is tightened, pushing the rotor core 20 back so that one side end surface of the rotor core 20 abuts against the receiving portion 32 of the rotor shaft 30, thereby fixing the rotor core 20 to the rotor shaft 30.

In the related art, position 33 at one end side of the outer diameter threaded structure 40 is set so as to become position 28 of the other end surface of the rotor core 20 when the rotor core 20 having a typical value for the axial dimension is assembled to the rotor shaft 30, and the one end surface in the axial direction of the rotor core 20 is abutted against the receiving portion 32. That is, in the related art, when the rotor core 20 has typical dimensions, the outer diameter threaded structure 40 and the rotor core 20 will not overlap. This is to avoid an unstable fit between the rotor core 20 and the rotor shaft 30 due to a radial gap forming therebetween when the outer diameter threaded structure 40 and the rotor core 20 overlap, because the outer diameter of the male thread of the outer diameter threaded structure 40 is smaller than the diameter of the center hole of the rotor core 20.

In this way, with the related art, the position in which the outer diameter threaded structure 40 is arranged on the rotor shaft 30 is set matching the typical axial dimension that does not account for dimensional variation in the axial direction of the rotor core 20. Therefore, if there is dimensional variation in the axial direction of the rotor core 20, the position 34 of the one end side of the outer diameter threaded structure 40 will differ from the position 28 of the other end surface of the rotor core 20. If the dimension of the rotor core 20 in the axial direction is shorter than the typical value, a gap forms between the other end surface of the rotor core 20 and the end portion of the outer diameter threaded structure 40. Fastening using the outer diameter threaded structure 40 and the nut portion 50 is unable to be performed in an area other than the area where the outer diameter threaded structure 40 is provided, so when the position in which the outer diameter threaded structure 40 is arranged is set as it is in the related art, sufficient tightening force to fix the rotor core 20 to the rotor shaft 30 may be unable to be obtained.

Therefore, the position in which the outer diameter threaded structure 40 is arranged with respect to the rotor core 20 is modified from that in the related art such that sufficient tightening force is able to be obtained, even if there is dimensional variation in the axial direction of the rotor core 20. That is, as shown in FIGS. 1 and 2, regarding the relationship of the position 28 of a contact surface between the rotor core 20 and the nut portion 50 when rotor core 20 is fixed to the rotor shaft 30 by the nut portion 50 being fastened to the outer diameter threaded structure 40 of the rotor shaft 30, the position 28 of the contact surface is positioned farther to the other end side in the axial direction than the position 34 of the one end side of the outer diameter threaded structure 40. That is, the rotor core 20 and the outer diameter threaded structure 40 are made to overlap.

If the overlap length in the axial direction between the rotor core 20 and the outer diameter threaded structure 40 is too long, backlash will occur between the outer diameter threaded structure 40 and the center hole of the rotor core 20. If the overlap length is too short, sufficient tightening force will not be able to be obtained. Therefore, the overlap amount is set based on the amount of dimensional variation in the axial direction of the rotor core 20 due to the amount of stacking variation in the stacked body 22 of the rotor core 20 and the amount that the stacked body 22 is squeezed when the rotor core 20 is being fastened and the like, and the backlash allowance between the outer diameter threaded structure 40 and the rotor core 20 and the like. The overlap length may be a range within equal to or greater than one screw pitch and within three screw pitches of the outer diameter threaded structure 40, preferably equal to or greater than 1.5 screw pitches, and more preferably equal to or greater than 2 screw pitches. That is, the position 34 on the one end side of the outer diameter threaded structure 40 in the axial direction is farther to the rotor core side than the position 28 of the contact surface of the nut portion 50 and the rotor core 20 by one screw pitch of the outer diameter threaded structure 40. The screw pitch differs depending on the outer diameter of the rotor shaft 30 and the like, but is anywhere from 1 millimeter to several millimeters, for example.

By overlapping the rotor core 20 and the outer diameter threaded structure 40 and suitably setting the overlap amount in this way, the nut portion 50 is able to be pushed to the side with the rotor core 20 and obtain a predetermined tightening force even if there is dimensional variation in which the dimension of the rotor core 20 in the axial direction is short, for example. Therefore, the rotor core 20 is able to be fixed to the rotor shaft 30 with a predetermined tightening force regardless of dimensional variation of the rotor core 20 in the axial direction.

In this way, the nut portion 50 pushes the rotor core 20 on the rotor shaft 30 toward the one end side and fixes the rotor core 20 to the rotor core 20 using the outer diameter threaded structure 40 that overlaps with the rotor core 20.

The pushing by the nut portion 50 is performed as described below. That is, the inner diameter thread 54 of the nut portion 50 meshes with the outer diameter threaded structure 40 and turns around its axis, pushing the rotor core 20 at the surface on the one end side of the nut portion 50 while causing the rotor core 20 to abut against the receiving portion 32 side of the rotor shaft 30, and stopping when the tightening force becomes a predetermined amount. FIGS. 1 and 2 are views showing the rotor core 20 in a state fixed to the rotor shaft 30 by the nut portion 50 being fastened to the outer diameter threaded structure 40 of the outer diameter threaded structure 40 in this way. In this state, the position 28 of the contact surface between the rotor core 20 and the nut portion 50 along the axial direction of the rotor shaft 30 is positioned farther to the other end side in the axial direction than the position 34 of the outer diameter threaded structure 40 on the one end side. That is, the rotor core 20 and the outer diameter threaded structure 40 are overlapped.

When the position of the nut portion 50 is determined by the pushing process, the nut portion 50 is fixed with respect to the rotor shaft 30 in this position. The nut portion 50 is fixed by a thin crimping portion of the nut portion 50 being crimped to the outer diameter threaded structure 40 of the rotor shaft 30. A thin crimping portion 59 after the crimping process is shown in FIGS. 1 and 2.

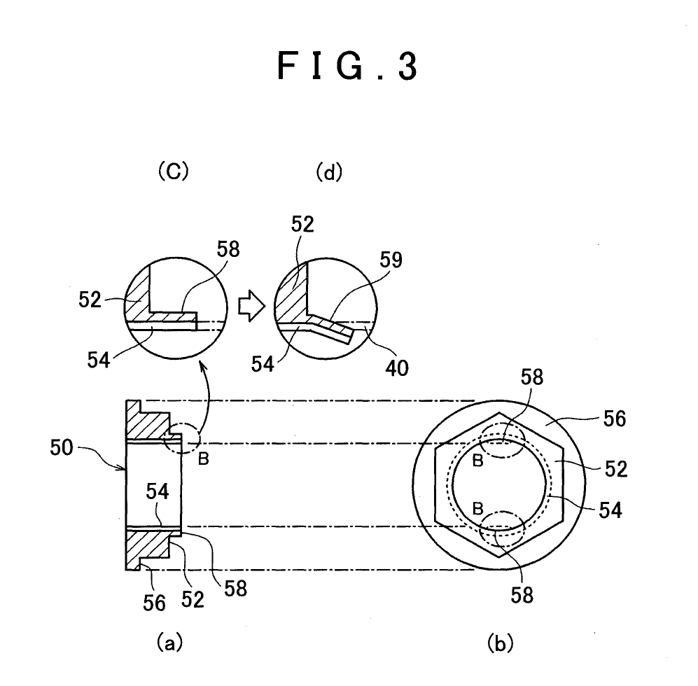

FIG. 3 is a detailed view of the nut portion 50. (a) to (c) of FIG. 3 are views of the nut portion 50 before crimping is performed, (a) is a sectional view, (b) is a plan view, and (c) is an enlarged view of portion B in (a). (d) of FIG. 3 is an enlarged view of portion B after crimping is performed. The nut portion 50 has the inner diameter thread 54 on an inner diameter side, and has screw shaft portion 52 with a hexagonally-shaped outer diameter, a circular flange portion 56 having a shape that envelops the hexagonal shape of the screw shaft portion 52, and a thin crimping portion 58 that extends from the screw shaft portion 52 toward the other end side in the axial direction. The nut portion 50 may be made of metal material having suitable, strength. Steel or the like may be used as the metal material.

The nut portion 50 is an extending portion that is able to be deformed by crimping, and is thin enough to be crimped and has a predetermined crimping strength. The required crimping strength is such that the nut portion 50 must not break when a predetermined torque is applied to the nut portion 50 in the loosening direction after crimping. The thickness and axial length of the thin crimping portion 58, the crimping width in the circumferential direction, and the number of crimping locations and the like, are set based on the strength of the material of the nut portion 50 so as to satisfy this condition.

The dimensions and crimping length of the thin crimping portion 58, and the number of crimping locations and the like, differ depending on the thread shape of the outer diameter threaded structure 40 of the rotor shaft 30, and the required crimping strength and the like. As an example, the thickness of the thin crimping portion 58 may be from approximately 1 mm to approximately 2 mm, and the axial length may be from approximately 2 mm to approximately 5 mm. The number of crimping locations is two in the circumferential location in the example shown in (b) of FIG. 3. The crimping width in the circumferential direction may be from approximately 2 mm to approximately 5 mm.

According to the structure shown in FIGS. 1 to 3, the outer diameter threaded structure 40 of the rotor shaft 30 is provided inside the rotor core 20, so as to overlap with the rotor core 20 by a predetermined overlap amount. Therefore, regardless of whether the dimensional variation in the axial direction of the rotor core 20 is such that the dimension is on the long side or the short side, the rotor core 20 is able to be fixed to the rotor shaft 30 with a predetermined tightening force.

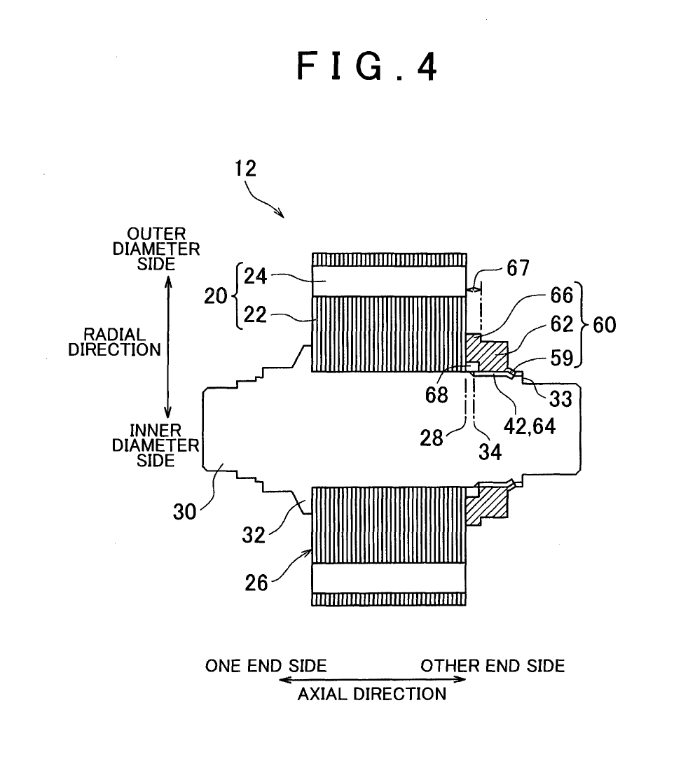

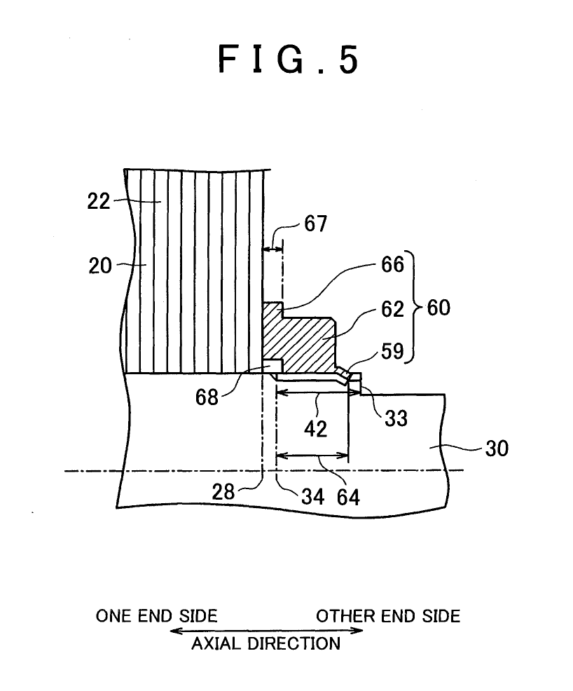

Next, a second example embodiment of the invention will be described. FIGS. 4 and 5 are views of the structure of a rotor 12 according to the second example embodiment capable of eliminating backlash between the rotor core 20 and the rotor shaft 30, even without extending the outer diameter threaded structure of the rotor shaft 30 inside the rotor core 20. FIG. 4 is a view corresponding to FIG. 1, and FIG. 5 is a view corresponding to FIG. 2. The rotor 12 differs from the rotor 10 having the structure shown in FIGS. 1 to 3, in terms of an outer diameter threaded structure 42 of the rotor shaft 30 and a nut portion 60.

The nut portion 60 has a threaded shaft portion 62 having an inner diameter thread 64 that meshes with the outer diameter threaded structure 42 of the rotor shaft 30, a flange portion 66 that has a slightly larger outer shape than the threaded shaft portion 62 and that pushes on the other end of the rotor core 20, and a thin crimping portion. The thin crimping portion is the same as that illustrated in FIGS. 1 to 3. The thin crimping portion 59 after crimping is shown in FIGS. 4 and 5.

The flange portion 66 has a larger outer diameter than the outer shape of the threaded shaft portion 62 on the one end side of the threaded shaft portion 62, and has a larger inner diameter than the outer shape of the rotor shaft 30. Here, a position of one end of the flange portion 66 in the axial direction protrudes out toward the one end side from the position of one end of the inner diameter thread 64 of the threaded shaft portion 62 by a predetermined protrusion length 67. As described above, the inner diameter of the flange portion 66 is set larger than the outer diameter of the rotor shaft 30, so a space 68 is formed between one end of the flange portion 66 and the other end of the rotor core 20. The length of the space 68 in the axial direction is set the same as the protrusion length 67. As a result, one of the one end of the inner diameter thread 64 of the threaded shaft portion 62 and the one end of the outer diameter threaded structure 42 of the rotor shaft 30 will not interfere with a corner on the inner diameter side of the other end surface of the rotor core 20.

The outer diameter threaded structure 42 is provided extending from the other end side of the rotor shaft 30 to the one end side of the rotor shaft 30, and the position 34 on the one end side of the outer diameter threaded structure 42 is a position farther to the other end side of the rotor shaft 30 than the position 28 of a contact surface between the flange portion 66 and the rotor core 20 when the rotor core 20 is fastened and fixed by the nut portion 60. The area between position 33 and position 34 is an area where the outer diameter-threaded structure 42 is provided. The position 34 on the one end side of the outer diameter threaded structure 42 is set to within the protrusion length 67 of the flange portion 66 from the position 28 of the contact surface between the flange portion 66 and the rotor core 20. That is, the outer diameter threaded structure 42 is not provided inside the rotor core 20, so the rotor core 20 and the outer diameter threaded structure 42 do not overlap.

In this way, according to the structure shown in FIGS. 4 and 5, when the rotor core 20 is fixed to the rotor shaft 30 by the nut portion 60 being fastened to the outer diameter threaded structure 42 of the rotor shaft 30, the position 28 on the rotor shaft 30 of the contact surface between the rotor core 20 and the flange portion 66 is positioned farther to the one end side in the axial direction than the outer diameter threaded structure 42. Also, the space 68 is formed on the one end side with the nut portion 60, compared to the nut portion 50 which is shown in FIG. 3. In this way, the rotor core 20 is able to be pushed by the flange portion 66 of the nut portion 60, while stabilizing the fit between the rotor core 20 and the rotor shaft 30 by not having the outer diameter threaded structure 42 overlap with the rotor core 20.

By preparing the nut portion 50 and the nut portion 60 in advance, the axial position and length of the outer diameter threaded structure 40 and 42 provided on the rotor shaft 30 is also able to be fixed beforehand. That is, depending on the dimensional variation in the axial direction of the rotor core 20, the nut portion 50 is used when the position 28 of the contact surface between the nut portion and the rotor core 20 when the rotor core 20 is fit onto the rotor shaft 30 and tightened with the nut portion, is farther toward the other end side of the rotor core 20 than the position of the one end of the outer diameter threaded structure. The nut portion 60 is used when the position 28 of the contact surface is farther toward the one end side of the rotor core 20 than the position of the one end of the outer diameter threaded structure. This enables the rotor core 20 to be fixed to the rotor shaft 30 with a predetermined tightening force by a screw tightening method, across a wide range of dimensional variation in the axial direction of the rotor core 20.

In the above description, the stepped portion of the rotor shaft 30 is described as the receiving portion 32 against which the one end surface of the rotor core 20 abuts. Alternatively, however, a screw tightening structure formed by the outer diameter threaded structure and nut portion described above may be provided on the one end side of the rotor shaft 30, and the one end surface of the rotor core 20 may be made to abut against the surface of the other end of this nut portion.

1. A rotary electric machine rotor comprising:
a rotor core that is provided by stacked thin magnetic plates, the rotor core having a center hole in the rotor core;
a rotor shaft that has a receiving portion on one end side of the rotor shaft and an outer diameter threaded structure on the other end side of the rotor shaft, the receiving portion being configured to abut on one end surface in an axial direction of the rotor core, an outer shape of the rotor shaft passing through the center hole of the rotor core; and
a nut portion that meshes with the outer diameter threaded structure of the rotor shaft,
wherein a first position, on the rotor shaft, of a contact surface between the nut portion and the rotor core is offset by a predetermined distance in the axial direction from a second position on one end side in the axial direction of the outer diameter threaded structure, when the nut portion is fastened to the outer diameter threaded structure of the rotor shaft and the rotor core is fixed to the rotor shaft by the nut portion, wherein
the first position, on the rotor shaft, of the contact surface between the nut portion and the rotor core is positioned farther to the other end side in the axial direction than the second position on the one end side in the axial direction of the outer diameter threaded structure:, when the nut portion is fastened to the outer diameter threaded structure of the rotor shaft and the rotor core is fixed to the rotor shaft by the nut portion, wherein the nut portion has a thin crimping portion that extends to the other end side in the axial direction.

2-3. (canceled)

4. The rotary electric machine rotor according to claim 1, wherein
the second position on the one end side in the axial direction of the outer diameter threaded structure is farther to the rotor core side than the first position of the contact surface between the nut portion and the rotor core by equal to or greater than one screw pitch of the outer diameter threaded structure.

5. The rotary electric machine rotor according to claim 4, wherein
the second position on the one end side in the axial direction of the outer diameter threaded structure is farther to the rotor core side than the first position of the contact surface between the nut portion and the rotor core by equal to or greater than one screw pitch and within three screw pitches of the outer diameter threaded structure.

6. The rotary electric machine rotor according to claim 1, wherein
the receiving portion is a stepped portion provided on the one end side of the rotor shaft.

7. A rotary electric machine rotor comprising:
a rotor core that is provided by stacked thin magnetic plates, the rotor core having a center hole in the rotor core;
a rotor shaft that has a receiving portion on one end side of the rotor shaft and an outer diameter threaded structure on the other end side of the rotor shaft, the receiving portion being configured to abut on one end surface in an axial direction of the rotor core, an outer shape of the rotor shaft passing through the center hole of the rotor core; and
a nut portion that meshes with the outer diameter threaded structure of the rotor shaft,
wherein a first position, on the rotor shaft, of a contact surface between the nut portion and the rotor core is offset by a predetermined distance in the axial direction from a second position on one end side in the axial direction of the outer diameter threaded structure, when the nut portion is fastened to the outer diameter threaded structure of the rotor shaft and the rotor core is fixed to the rotor shaft by the nut portion, wherein
the nut portion also has a flange portion that protrudes out to the one end side in the axial direction from a threaded shaft portion, the threaded shaft portion being configured to mesh with the outer diameter threaded structure of the rotor shaft, the flange portion having a larger outer shape than the threaded shaft portion, and the flange portion being configured to push on the other end surface of the rotor core, and
the first position, on the rotor shaft, of a contact surface between the flange portion of the nut portion and the rotor core is positioned farther to the one end side in the axial direction than the second position on the one end side in the axial direction of the outer diameter threaded structure, when the nut portion is fastened to the outer diameter threaded structure of the rotor shaft and the rotor core is fixed to the rotor shaft by the nut portion, wherein
the nut portion has a thin crimping portion that extends to the other end side in the axial direction.

8. (canceled)

9. The rotary electric machine rotor according to claim 7, wherein the receiving portion is a stepped portion provided on the one end side of the rotor shaft.
